(19) United States
(12) Patent Application Publication
(10) Pub. No.: US 2007/0170733 A1
(43) Pub. Date: Jul. 26, 2007

(54) SPATULA

(76) Inventors: Mathieu Lion, Paris (FR); Lucas Bignon, Cachan (FR)

Correspondence Address: PATENT DOCKET CLERK;COWAN, LIEBOWITZ & LATMAN, P.C., 1133 AVENUE OF THE AMERICAS, NEW YORK, NY, 10036, US

(21) Appl. No.: 11/626,432

(22) Filed: Jan. 24, 2007

(30) Foreign Application Priority Data
Jan. 26, 2006 (EP) 06290162.4

(51) Int. Cl. A47J 43/28

(52) U.S. Cl. 294/7

(57) ABSTRACT

A spatula having a handle and a blade extending from the handle. The blade has at least one curved, convex section, along the blade's length. The curved, convex section forms a line that is not aligned with the handle's longitudinal axis.

### BACKGROUND OF THE INVENTION

1. Field of the Invention

The present invention relates to kitchen tools and, more particularly, to a spatula or palette type of tool for use in a kitchen.

2. Description of the Related Art

Spatulas are well known and come in various shapes and sizes. Typical spatulas are made of metal or plastic and include a relatively flat food handling surface and a handle extending therefrom. Generally, the food handling surface is heat resistant to allow for direct contact of heated pans and other hot surfaces. There are many different types, shapes, sizes and configurations of spatulas, but despite the existence of a great variety of spatulas and like kitchen utensils, there still is considerable room for improvement in the field of kitchen utensils and, particularly, spatulas.

### OBJECTS AND SUMMARY OF THE INVENTION

Therefore, it is an object of this invention to provide a tool having properties that are superior to the current state of technology. More specifically, it is an object of this invention to provide a light, multi-use tool that is easily washed by hand and by machine, and that is resistant to a large range of temperatures.

It is a further object of this invention to provide an ergonomic tool, in particular, a tool that is designed to easily turn over (or flip) various items, such as, for example, pancakes, griddle cakes, meat, toast, fish, etc., during cooking.

The above objects and others are achieved by a spatula in accordance with the present invention that includes a handle that extends along a handle axis, and a blade that extends from the handle. The blade has at least one curved, convex section, along a length of the blade length. The curved, convex section forms a line that is not aligned with the handle axis.

As an aspect of the invention, the blade includes a curved, concave, longitudinal section.

As another aspect of the invention, a silicone cover is disposed over the blade.

As a further aspect of the invention, a cover is disposed over the blade, and the cover is made of a thermoplastic material.

As an additional aspect of the invention, the blade is comprised of an inner frame and an outer cover fully disposed over the inner frame.

As a feature of this aspect, the inner frame is made of metal.

As a further feature of this aspect, the inner frame is made of spring steel.

As another feature of this aspect, the inner frame is made of a thermoplastic material.

As an additional feature of this aspect, the inner frame is substantially flat and includes curved sections.

As a further aspect of the invention, the blade fully covers the inner frame.

As a feature of this aspect, the inner frame has a thickness of substantially between 1 and 2 mm.

As a further feature of this aspect, the inner frame has a length of substantially between 20 and 30 cm.

As another feature of this aspect, the inner frame extends from a first end adjacent the handle to a second end, and a width of the inner frame increases from the first end to the second end.

As an additional feature of this aspect, the inner frame extends from a first end adjacent the handle to a second end, a width of the first end of the inner frame being substantially between 10 and 20 mm, and a width of the second end of the inner frame being substantially between 15 and 30 mm.

As a further feature of this aspect, the inner frame has a deflection of substantially between 10 and 30 mm.

As yet another feature of this aspect, the inner frame has a mid-section length of substantially between 40 and 60 cm.

As yet an additional feature of this aspect, the inner frame includes an insert disposed within the handle.

As another aspect of the invention, the blade has a flat, external envelope and includes curved edges.

As a further aspect of the invention, the blade longitudinally extends from a first end adjacent the handle to a second end opposite the first end, and a width of the blade progressively increases from the first end to the second end.

As an additional aspect of the invention, the blade longitudinally extends from a first end adjacent the handle to a second end opposite the first end, and a width of the blade progressively increases from the first end to a mid-section between the first and second ends, and the width of the blade decreases from the mid-section to the second end.

As yet a further aspect of the invention, the blade longitudinally extends from a first end adjacent the handle to a second end opposite the first end, a width of the first end being substantially between 15 and 30 mm, and a width of the second end being substantially between 20 and 50 mm.

As yet an additional aspect of the invention, the blade has a thickness of substantially between 3 and 6 mm.

As yet another aspect of the invention, the blade has a length of substantially between 25 and 35 cm.

As yet a further aspect of the invention, the blade has a deflection of substantially between 15 and 40 mm.

As yet an additional aspect of the invention, the blade includes a concave section, a mid-section of the blade at the concave section having a length of substantially between 40 and 60 cm.

As another aspect of the invention, the blade includes first and second substantially flat, longitudinal surfaces on opposite sides of the blade, the first and second surfaces converging to form at least one tapered cutting edge.

As a feature of this aspect, the tapered cutting edge is disposed along the convex section of the blade.

As a further feature of this aspect, the tapered cutting edge is disposed at an end of the blade opposite the handle.

As another feature of this aspect, the tapered cutting edge of the blade extends from the convex edge of the blade at an angle of substantially between 50 to 80 degrees.

As an additional aspect of the invention, the blade and handle are made of the same material.

As a feature of this aspect, the material is a thermoplastic material.

As another aspect of the invention, the line formed by the convex section of the blade is disposed at an angle of substantially between 10 and 40 degrees with respect to the handle axis.

As an additional aspect of the invention, the blade is comprised of an inner frame and an outer cover fully disposed over the inner frame, the inner frame having a plurality of apertures and the outer cover extending through each of the apertures of the inner frame.

As yet a further aspect of the invention, the blade extends from the handle at a position defining a joint, and the joint having a strength that is weaker than strengths of the handle and the blade.

As yet another aspect of the invention, the blade has a width adapted to form a constant curvature of the blade under a constant effort by the handle, regardless of an area of curvature of the blade.

As yet an additional aspect of the invention, the handle and blade are symmetrical along a plane.

In accordance with another embodiment of the invention, a method of manufacturing a spatula comprises the steps of covering a long, substantially flat, semi-rigid, curved frame with a pliable material to form a blade, and forming, simultaneously to the covering step, a handle from which the formed blade extends.

As an aspect of this embodiment, the pliable material is silicone.

As a further aspect of this embodiment, the covering step is carried out to form a blade having at least one curved section, convex along a length of the blade, the curved section forming a line not aligned with a longitudinal axis of the formed handle.

As another aspect of this embodiment, the covering step is carried out to form a blade having first and second curved longitudinal sections, the first section being concave and the second section being convex.

As an additional aspect of this embodiment, the frame includes a plurality of apertures, and the method further comprises the steps of supporting the frame using the apertures during the covering and forming steps, and filling holes within the blade caused by supporting the frame during the supporting step.

Various other objects, advantages and features of the present invention will become readily apparent to those of ordinary skill in the art, and the novel features will be particularly pointed out in the appended claims.

### BRIEF DESCRIPTION OF THE DRAWINGS

The following detailed description, given by way of example and not intended to limit the present invention solely thereto, will best be appreciated in conjunction with the accompanying drawings, wherein like reference numerals denote like elements and parts, in which:

FIG. 1 is a schematic illustration showing a lateral view of the spatula of the present invention;

FIG. 2 is another schematic illustration of the spatula of the present invention, particularly showing an inner frame of the blade of the spatula;

FIG. 3 is a schematic illustration of the frame of the spatula of the present invention;

FIG. 4 is a schematic illustration showing a section view of the spatula of the present invention;

FIGS. 5, 6, and 7 are schematic illustrations showing three successive stages of turning of a food product, generally during a cooking operation, by the spatula of the present invention.

### DETAILED DESCRIPTION OF PREFERRED EMBODIMENTS

Referring to FIGS. 1-4 of the drawings, spatula 10 of the present invention includes an inner frame 20 completely covered by an outer silicone covering 30. Frame 20 and silicone covering 30 (also called herein “silicone cover 30” or “cover 30”) collectively form a spatula that includes a handle 12 and a blade 14 extending from the handle.

In accordance with the present invention, blade 14 is slightly pliable and includes a section (edge) 34 that is slightly curved and convex, along its length, forming a line 35 shown in FIG. 1 that is not aligned, that is, neither on the same axis nor on an axis that is parallel, with axis O-O (see FIG. 1) of handle 12. Moreover, and in accordance with the present invention, both first section 34 and a second section 32 of blade 14 are curved. The second section 32 is concave and forms a line that also is not aligned with axis O-O of handle 12. As a particular example, line 35 of blade 14 is inclined with axis O-O of handle 12 at an angle alpha of between 10 and 40 degrees, preferably around 20 degrees.

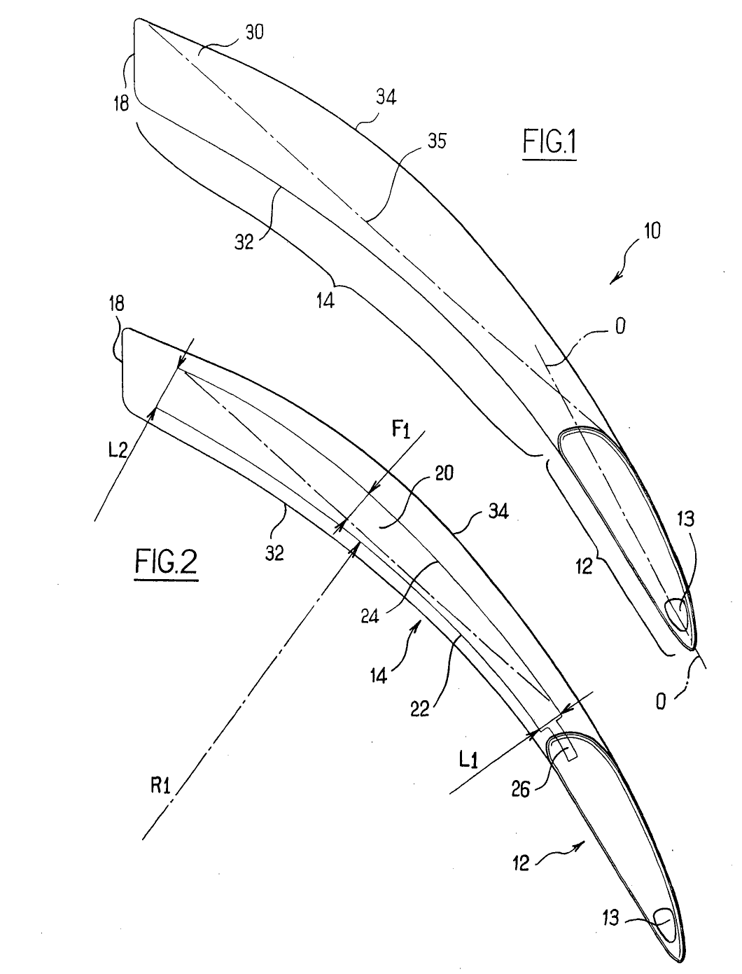

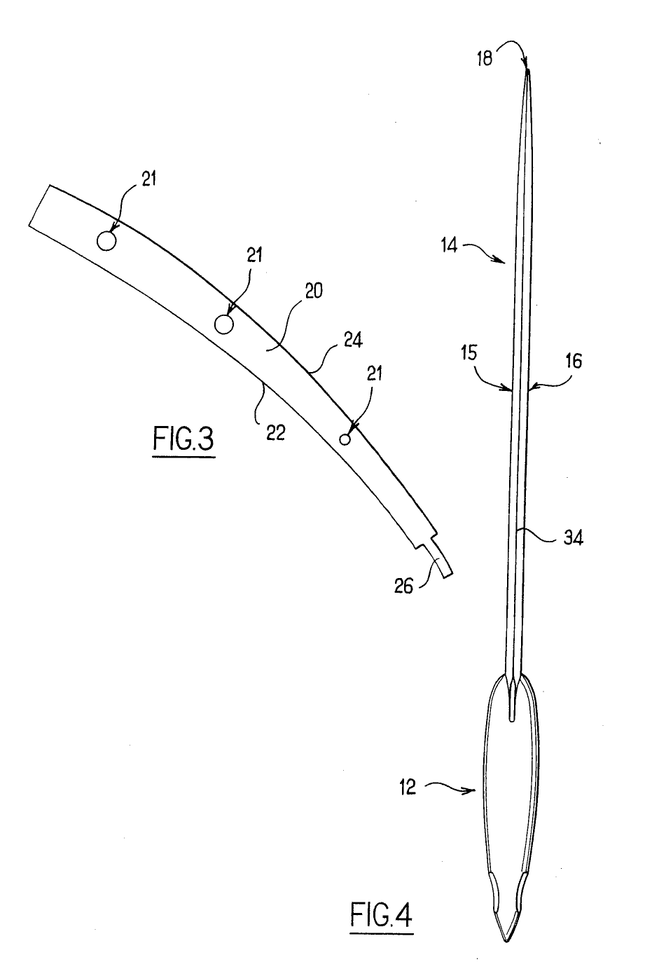

As shown in FIGS. 2 and 3, frame 20 includes a flat, long piece (i.e. component) that has two curved sections (or edges, surfaces) 22 and 24. As shown, the geometry of frame 20 is generally crown style. Section 22 is concave and section 24 is convex.

In accordance with the invention, frame 20 preferably is constructed of metal (e.g., steel) and, preferably, is spring steel. In a variation, frame 20 is made of any suitably strong material, for example, a thermoplastic material, and preferably a material that is sufficiently elastic and pliable to allow for adequate deformation of blade 14 during use.

As a particular example, the spatula of the present invention may have the following dimensions and structure. A frame 20 with a thickness of between 1 and 2 mm, and a length of between 20 and 30 cm, preferably around 25 cm. Frame 20 gradually is wider from its end adjacent to handle 12 and, typically, frame 20 has a width L1 of between 10 and 20 mm, preferably around 13 mm at an end that is next to handle 12, and a width L2 of between 15 and 30 mm, preferably around 18 mm at the opposite end. The frame forms at its convex external section 24 a deflection F1 of between 10 and 30 mm, preferably around 15 mm, and a middle area R1 of concave section 22 of between 40 and 60 cm, preferably around 50 cm.

The edges of frame 20 are smooth, that is, not sharp, so to eliminate or at least minimize damaging or cutting the silicone cover 30 (or anything else) during use.

Referring particularly to FIG. 3, frame 20, at the thinner end, has the general shape of a crown sector with a varying width, and extending from the thinner end is an insert 26 (also called herein “finger 26”). Finger 26 is imbedded within cover 30 at a portion thereof which forms handle 12 so as to provide a connection and continuity between a part of blade 14 and handle 12.

As stated above, cover 30 is made of silicone, which is both heat resistant and non-abrasive. In a variation, cover 30 may be made of a different, suitable material, such as a thermoplastic material.

As described herein, the spatula of the present invention includes a cover 30 that forms both handle 12 and is a covering for the entire frame 20. The shape and design of spatula 10 of the present invention is ergonomic for multiple uses, as further discussed below, and may be held in one hand. Preferably, handle 12 is formed of a long mass that is centered on a median axis O-O. Handle 12 may be slightly curved to lengthen the entire frame 20 and blade 14. Handle 12 has a generally oval right section. Preferably, handle 12 is symmetrical with the plane of FIGS. 1 and 2 and at right angles to the plane of the FIG. 4, said plane of symmetry also passing through that of blade 14.

Handle 12 may include an eyelet hole 13 to allow for the spatula of the present invention to hang from a suitable hook or peg, or to allow for a string, rope, etc. to pass through the eyelet hole 13 for whatever purpose, including allowing the spatula to hang from a peg, hook, etc., via the string.

Cover 30 (in the area of blade 14) forms an envelope with a shape similar to that of frame 20, as described above and shown in the figures. Preferably, blade 14 is long and flat, with two longitudinal curved sections 32 and 34 to provide the general shape of a crown. In a preferred version, spatula 10 of the present invention includes a blade with the following dimensions: an average thickness of between 3 and 6 mm; and a length of between 25 and 35 cm, preferably around 28 cm. Blade 14 preferably widens gradually as it extends from handle 12, with its narrowest section adjacent to handle 12 having a width of between 15 and 30 mm, preferably around 22 mm, and its widest section, at its free end, having a width of between 20 and 50 mm, preferably around 40 mm. In a particularly preferred version, the width of handle 12 slightly decreases at its free end (e.g., beginning in the vicinity of a mid-section F1 shown in FIG. 2). The deflection formed on the convex section 34 of blade 14 may be between 15 and 40 mm, preferably around 20 mm, and the central area of the concave section 32 of blade 14 is between 40 and 60 cm, preferably around 50 cm.

As shown in FIG. 4, surfaces 15 and 16 of blade 14 converge around convex external tapered edge 34 to form the tapered edge. The same configuration preferably is provided at the end of blade 14 opposite handle 12. Blade 14 has an outer edge 18 inclined against concave section 32 and outer convex edge 34. That is, surfaces 15 and 16 of cover 30 converge at their ends to form tapered edge 18. Advantageously, both surfaces (edges) 18 and 34 may be utilized to cut various food products (e.g., pancakes, eggs, etc.). Edge 18 preferably forms an obtuse angle with the concave section 32 and an acute angle with external convex section 34. Edge 18 preferably is inclined by 50 to 80 degrees against external convex edge 34, more preferably by about 70 degrees to form a convex side edge.

Spatula 10 of the present invention may be manufactured in a manner known in the art, for instance, in two stages wherein, during a first stage, frame 20 is held (by a suitable device) at insert 26 and a part of cover 30 over frame 20 is formed and then, during a second stage, while cover 30 over frame 20 is held (by a suitable device) the handle 12 is made.

In accordance with the present invention, spatula 10 of the present invention may be manufactured in various different, novel manners. In such various manners, handle 12 is manufactured simultaneously with the frame 20's outer covering, as described below.

In a first manufacturing method in accordance with the present invention, frame 20 is held, e.g., inside a mold, by any suitable device, such as a thin metal extension, and then all of the silicone, comprising both handle 12 and the covering of frame 20, is injected into the mold to form handle 12 and the frame's covering. Thereafter, the holding mechanism is removed and any gap formed (by the existence of the holding mechanism) is filled with silicone.

In a particular version of this manufacturing method, frame 20 is provided with plural apertures 21, such as shown in FIG. 3, through which thin retaining bars or other suitable mechanism passes to hold frame 20 in place followed by the forming of handle 12 and the outer covering of frame 20 by any known method, including injection molding as mentioned above. Thereafter, the holding mechanism (e.g., the thin retaining bars) are removed and the small gaps (i.e., holes) that remain in the silicone as a result of the existence of the holding mechanism are filled with silicone to, in a sense, seal off the holes.

In yet another variation of the manufacturing method of the present invention, and still referring to FIG. 3, the covering material 30 (silicone) is formed around frame 20 and due to the existence of apertures 21, the covering material passes through the apertures 21 within frame 20 to result in a strong bonding between the covering material formed on both sides of frame 20.

In each of the variations of the spatula of the present invention discussed herein, the shape and structure of frame 20, the characteristics of the material of cover 30, and the shape of cover 30 are designed so that a slight bending point (or point of weakness) is provided in the vicinity of the intersection (or joint) between handle 12 and blade 14. With such construction, the spatula is able to bend at this intersection during use. Blade 14, however, remains overall rectilinear when stressed transversely along its mid-section.

Preferably, blade 14 has a width (particularly in the region over frame 20) that has a constant average curvature, and thus constant effort is applied via handle 12 during use regardless of the area of the curvature.

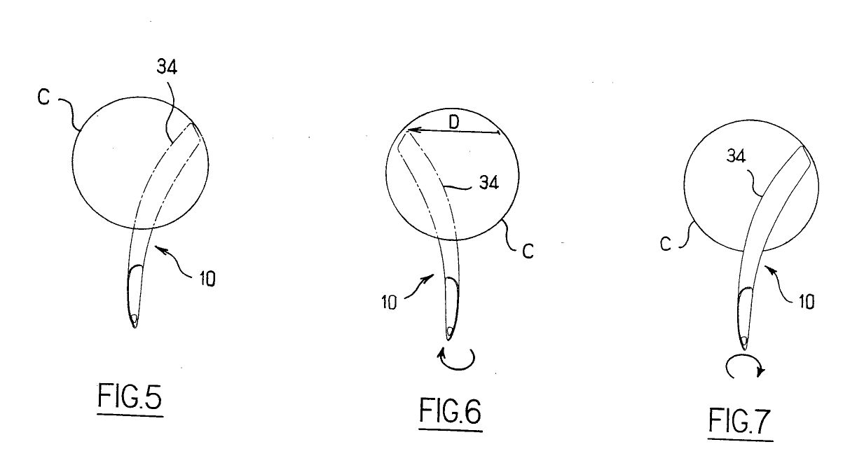

FIGS. 5, 6 and 7 are schematic illustrations showing a flipping over of a food product (e.g., pancake, griddle cake, etc.) operation by the spatula of the present invention. FIG. 5 is a schematic illustration of spatula 10 sliding under a food product C (e.g., a pancake) with the convex, tapered section on the left. FIG. 6 is a schematic illustration showing the position of spatula 10 after 180 degree rotation around the handle's longitudinal axis O-O shown in FIG. 1. Such rotation being achieved by the turn of a user's hand holding the spatula's handle. Such rotation also principally causing only movement of the upper end of the spatula's blade as shown in FIGS. 5 and 6. In particular, during such rotation, the spatula's blade end moves from one (a first or original) position to another (a second) position that is double the distance as compared to the distance from the edge of the spatula to the handle's longitudinal axis O-O (see FIG. 1). As previously described, the line which connects the two ends of convex section 34 and blade 14 is not aligned with the handle's axis O-O. As shown in FIG. 6, the displacement of the blade's end between the first and second positions is identified as distance “D.” Finally, spatula 10 is rotated 180 degrees (in the opposite direction as the above-mentioned rotation) to cause food product C to flip over, as shown in FIG. 7.

As described herein, the spatula of the present invention is flexible, heat-resistant and provides for the quick and easy turning over (flipping) of various food products during cooking. The spatula of the present invention generally is symmetrically perpendicular to the plane of FIG. 4 and parallel to the planes shown in FIGS. 1 and 2 and, thus, the spatula is ambidextrous. That is, the spatula may be used equally well by either a user's right hand or left hand.

The spatula of the present invention has been particularly shown in the drawings and as described in the description herein. However, it is appreciated that the spatula may be modified in various manners. As one example, the shape of handle 12 may be different from that shown in the drawings. As a further example, the various dimensions of the various components of the spatula described herein may be different than those enumerated. As yet another example, the spatula of the present invention may be made of a single material, for example, a thermoplastic material.

Therefore, it is intended that the appended claims be interpreted as including the embodiments described herein, the alternatives mentioned above, and all equivalents thereto.

What is claimed is:

1. A spatula, comprising:
a handle extending along a handle axis; and
a blade extending from the handle, the blade having at least one curved, convex section, along a length of the blade length, the curved, convex section forming a line not aligned with the handle axis.

2. The spatula according to claim 1, wherein the blade includes a curved, concave, longitudinal section.

3. The spatula according to claim 1, further comprising a silicone cover disposed over the blade.

4. The spatula according to claim 1, further comprising a cover disposed over the blade, the cover being made of a thermoplastic material.

5. The spatula according to claim 1, wherein the blade is comprised of an inner frame and an outer cover fully disposed over the inner frame.

6. The spatula according to claim 5, wherein the inner frame is made of metal.

7. The spatula according to claim 5, wherein the inner frame is made of spring steel.

8. The spatula according to claim 5, wherein the inner frame is made of a thermoplastic material.

9. The spatula according to claim 5, wherein the inner frame is substantially flat and includes curved sections.

10. The spatula according to claim 1, further comprising an inner frame, the blade fully covering the inner frame.

11. The spatula according to claim 10, wherein the inner frame has a thickness of substantially between 1 and 2 mm.

12. The spatula according to claim 10, wherein the inner frame has a length of substantially between 20 and 30 cm.

13. The spatula according to claim 10, wherein the inner frame extends from a first end adjacent the handle to a second end, and a width of the inner frame increases from the first end to the second end.

14. The spatula according to claim 10, wherein the inner frame extends from a first end adjacent the handle to a second end, a width of the first end of the inner frame being substantially between 10 and 20 mm, and a width of the second end of the inner frame being substantially between 15 and 30 mm.

15. The spatula according to claim 10, wherein the inner frame has a deflection of substantially between 10 and 30 mm.

16. The spatula according to claim 10, wherein the inner frame has a mid-section length of substantially between 40 and 60 cm.

17. The spatula according to claim 10, wherein the inner frame includes an insert disposed within the handle.

18. The spatula according to claim 1, wherein the blade has a flat, external envelope and includes curved edges.

19. The spatula according to claim 1, wherein the blade longitudinally extends from a first end adjacent the handle to a second end opposite the first end, and a width of the blade progressively increases from the first end to the second end.

20. The spatula according to claim 1, wherein the blade longitudinally extends from a first end adjacent the handle to a second end opposite the first end, and a width of the blade progressively increases from the first end to a mid-section between the first and second ends, and the width of the blade decreases from the mid-section to the second end.

21. The spatula according to claim 1, wherein the blade longitudinally extends from a first end adjacent the handle to a second end opposite the first end, a width of the first end being substantially between 15 and 30 mm, and a width of the second end being substantially between 20 and 50 mm.

22. The spatula according to claim 1, wherein the blade has a thickness of substantially between 3 and 6 mm.

23. The spatula according to claim 1, wherein the blade has a length of substantially between 25 and 35 cm.

24. The spatula according to claim 1, wherein the blade has a deflection of substantially between 15 and 40 mm.

25. The spatula according to claim 1, wherein the blade includes a concave section, a mid-section of the blade at the concave section having a length of substantially between 40 and 60 cm.

26. The spatula according to claim 1, wherein the blade includes first and second substantially flat, longitudinal surfaces on opposite sides of the blade, the first and second surfaces converging to form at least one tapered cutting edge.

27. The spatula according to claim 26, wherein the tapered cutting edge is disposed along the convex section of the blade.

28. The spatula according to claim 26, wherein the tapered cutting edge is disposed at an end of the blade opposite the handle.

29. The spatula according to claim 28, wherein the tapered cutting edge of the blade extends from the convex edge of the blade at an angle of substantially between 50 to 80° angle.

30. The spatula according to claim 1, wherein the blade and handle are made of the same material.

31. The spatula according to claim 30, wherein the material is a thermoplastic material.

32. The spatula according to claim 1, wherein the line formed by the convex section of the blade is disposed at an angle of substantially between 10 and 40 degrees with respect to the handle axis.

33. The spatula according to claim 1, wherein the blade is comprised of an inner frame and an outer cover fully disposed over the inner frame, the inner frame having a plurality of apertures and the outer cover extending through each of the apertures of the inner frame.

34. The spatula according to claim 1, wherein the blade extends from the handle at a position defining a joint, and the joint having a strength that is weaker than strengths of the handle and the blade.

35. The spatula according to claim 1, wherein the blade has a width adapted to form a constant curvature of the blade under a constant effort by the handle, regardless of an area of curvature of the blade.

36. The spatula according to claim 1, wherein the handle and blade are symmetrical along a plane.

37. A method of manufacturing a spatula, comprising the steps of:
covering a long, substantially flat, semi-rigid, curved frame with a pliable material to form a blade;
forming, simultaneously to the covering step, a handle from which the formed blade extends.

38. The method of claim 37, wherein the pliable material is silicone.

39. The method of claim 37, wherein the covering step is carried out to form a blade having at least one curved section, convex along a length of the blade, the curved section forming a line not aligned with a longitudinal axis of the formed handle.

40. The method of claim 37, wherein the covering step is carried out to form a blade having first and second curved longitudinal sections, the first section being concave and the second section being convex.

41. The method of claim 37, wherein the frame includes a plurality of apertures; the method further comprising the steps of supporting the frame using the apertures during the covering and forming steps; and filling holes within the blade caused by supporting the frame during the supporting step.
